(19) United States
(12) Patent Application Publication
(10) Pub. No.: US 2005/0076808 A1
(43) Pub. Date: Apr. 14, 2005

(54) Dental application device

(76) Inventors: Steffen Assmann, Friedberg (DE); Peter Appel, Woelfersheim (DE); Reinhard Armbrust, Bad Vilbel (DE)

Correspondence Address: NATH & ASSOCIATES, 1030 15th STREET, NW, 6TH FLOOR, WASHINGTON, DC, 20005, US

(21) Appl. No.: 10/499,537

(22) PCT Filed: Jun. 23, 2003
(86) PCT No.: PCT/EP03/06577

(30) Foreign Application Priority Data
Jun. 21, 2002 (DE) 102 28 498.9

(51) Int. Cl. C09K 3/00

(52) U.S. Cl. 106/35

(57) ABSTRACT

The invention comprises a discharge device for dental purposes. This discharge device is filled with a dental ceramic material, preferably an opaque in dispersible form, in particular in the form of a solution or suspension. The discharge device is in particular a spray can.

The invention relates to a discharge device for dental purposes, to dental ceramic materials and to a method for applying dental ceramic materials.

Tooth replacements, such as for example tooth crowns or tooth bridges, are made up from a dental frame, often a metal frame. This frame is then blended with other materials, in particular ceramic materials or plastic materials. In this context, particular mention should be made of the restorations which are blended with ceramic and are particularly tailored to medical and aesthetic requirements.

In the latter cases, the ceramic blending material is usually built up in a number of layers on the, for example, metallic or ceramic basic frame. In this context, the first layer or one of the first layers applied to the frame is often a so-called opaque layer made from a dental opaque. This opaque serves the purpose of covering over the color of the metal or ceramic which forms the basic frame. Then, one or more further layers of ceramic material, which are referred to as dentine layer(s), is applied to this opaque layer. Then, so-called incisal layers and if appropriate also glazed layers of ceramic materials are applied above the dentine layer(s).

The ceramic materials mentioned are generally supplied by the corresponding manufacturers in the form of powders, and also, in the case of opaques, as pastes. The dental technician then produces ready-to-use mixtures from these starting materials, in particular from the powders, with the aid of suitable solvents.

The abovementioned procedures have a number of drawbacks. In the case of ceramic pastes, the dental technician has to accept long pre-drying times, on account of the highly volatile solvent constituents which are present. In the case of the ceramic powders, the dental technician is not provided with a product which is ready to use, and consequently time has to be expended on production of this ready-to-use product. Secondly, the production of the ready-to-use product for each individual application represents a constant source of possible faults, for example if the manufacturer's instructions are not or cannot be adhered to for various reasons.

Accordingly, the invention is based on the object of eliminating the abovementioned drawbacks and providing dental ceramic materials in the ready-to-use state.

This object is achieved by the discharge device and the dental ceramic material having the features of claims 1 and 12, respectively. The invention also relates to the method described in claim 15. Preferred embodiments of certain subjects of the invention are given in claims 2 to 11, 13, 14 and 16 to 18. The wording of all the claims is hereby incorporated in the present description by reference.

According to the invention, a discharge device which is intended for dental purposes is filled with a dental ceramic material (usually ceramic powder) in dispersible form, in particular as a solution or suspension. The ceramic material is preferably a so-called dental opaque. The discharge device is preferably a spray device, in particular what is known as a spray can. According to the invention, the ceramic material is in the ready-to-use, premixed form, so that the drawbacks of the prior art described in the introduction are avoided.

According to the invention, the terms “solution” and “suspension” are to be interpreted very broadly. These terms are intended to encompass all situations in which the dental ceramic material is supplied in combination with an inorganic or organic solvent. Accordingly, the discharge device according to the invention may be filled, for example, with a (low-viscosity) solution (high solvent content) or with a (high viscosity) paste or the like (low solvent content). In this context, it should also be taken into account that the actual filling of the discharge device in the case of the invention is formed not only by the solution/suspension itself, but also by the propellant (usually at least one gas) which is required to discharge the ceramic material. In this way, the ceramic material is ultimately discharged in dispersed form, preferably as an aerosol. This is explained in more detail in the text which follows.

In principle, a very wide range of solvents can be used in the invention, in particular for production of the solution/suspension. However, it is preferable if these solvents are what are known as polar solvents, which can be used to achieve particularly good distribution of the ceramic particles. In this context, by way of example, the ketones or ethers may be mentioned as examples of possible solvents. Within the group of polar solvents, particular emphasis should be given to the alcohols, which may be monohydric or polyhydric alcohols. In this context, the alcanols, and especially ethanol, are particularly preferred.

According to the invention, the discharge device is preferably filled with a dental ceramic material which is in pasty, i.e. highly viscous, form. This material in paste form comprising the ceramic particles and the solvent then, together with the usually gaseous propellant, form the contents and therefore the actual filling of the discharge device, for example the spray can.

The ratio of the quantity of ceramic material (ceramic particles) to the quantity of solvent contained in the solution/suspension (paste) is preferably between 1:4 and 4:1 (parts by weight). Preferred quantitative ratios are from 2:3 to 3:2. Within the latter range, quantitative ratios of between 1:1 and 3:2 are particularly preferred.

The particle size of the ceramic particles used depends on the purpose for which the ceramic coating is to be applied. Ceramic opaque layers are usually produced from ceramic particles with a smaller particle size than the so-called dentine layers. The invention is preferably suitable for the application of opaque layers. Opaque layers of this type are usually applied to the dental frame with a relatively small layer thickness (50 μm to 200 μm, preferably 70 μm to 150 μm). The same is also true of the ceramic glaze layers which may optionally have been applied last. By contrast, the ceramic dentine layers are generally applied in much greater, non-uniform layer thicknesses (up to several millimeters), which means that although the invention can be used for dentine layers of this type, it is often not necessary to do so.

Accordingly, the particle sizes of the ceramic materials used to implement the invention (d₅₀ value) are preferably less than 80 μm, more preferably less than 30 μm. Further preferred particle sizes for the ceramic materials used (d₅₀ value) are between 2 μm and 20 μm, in particular between 3 μm and 8 μm.

As has already been mentioned, the actual filling of the discharge device according to the invention can also be defined as the mixture of the dental ceramic material, i.e. from the (low-viscosity) solution to the (optionally pasty) suspension, and the propellant (propellant gas) required to discharge this material. The quantitative or volumetric ratio between ceramic material (solution/suspension/paste) and propellant gas may, according to the invention, be set according to the ceramic material used or according to the desired use which is intended. The volumetric ratio of ceramic material (for example paste) to propellant gas is preferably between 1:5 and 5:1, preferably between 1:1 and 5:1. Volumetric ratios of ceramic material to propellant gas of between 1:1 and 2:1 are even more preferred within the latter range.

Apart from the new form of filling which is to be used in accordance with the invention, the remaining structure of the discharge device according to the invention is substantially known from the prior art. As has already been mentioned, these are preferably standard spray devices, for example spray cans, as are also used to discharge paints and the like. As a simple generalization, discharge devices of this type comprise a container and a so-called spray head.

In this context, the container, for example the spray can, may be of a suitable size which can be selected as desired and may often preferably hold a volume of approx. 50 ml to 100 ml. Containers of this type may be either uncoated on the inner sides or coated with lacquers or metal layers on the inner sides. The containers often also contain balls preferably glass beads, which can be used to shake up the filling before the spray head is actuated. Balls/glass beads of this type often have diameters of between 5 mm and 7 mm.

The spray head comprises a discharge valve, which is designed in the usual way in the style of a nozzle. These may be nozzles made from plastic or alternatively metal, for example brass. These nozzles also define the discharge angle for the dental ceramic material, as will be discussed in more detail below in connection with the method according to the invention.

There is no need for any further information relating to the spray head itself, since corresponding configurations are known from the prior art. A spray head of this type comprises, for example, a housing into which a riser which extends into the container opens out. The housing of the spray head comprises a spring which closes the nozzle itself by exerting pressure on a piston-like element. Actuation of a corresponding actuating element opens the nozzle/valve counter to the spring pressure, so that the filling in the container can escape through the nozzle for a corresponding period of time. The spray head itself is sealed with respect to the container by means of suitable steaming elements, preventing an undesirable escape of the filling. In principle, all substances/gases which are known from the prior art can be used as propellant/propellant gas for the discharge device according to the invention. These substances/gases may, for example, be ethers (dimethyl ether), nitrogen, compressed air, carbon dioxide and the like. Preferred propellant gases used are hydrocarbons, for example a mixture of propane and butane. All these gases are usually under a pressure of between 1 and 4 bar, with pressures of between 2 bar and 3 bar being preferred.

The subject matter of the invention can also be described as a dental ceramic material which is in dispersible form, in particular in the form of a solution or suspension, as the filling of a discharge device of this type, in particular a spray can.

As has already been explained, the dental ceramic material is preferably a so-called dental opaque. For the particularly preferred features of the dental ceramic material, express reference may be made in this context to the statements given above.

The method according the invention for applying a dental ceramic material to a base, in particular the surface of a dental frame structure, is characterized in that this material is applied to the corresponding surface in dispersed form, in particular as a solution or suspension, with the aid of the abovementioned discharge device/spray can. This surface may if appropriate have been pretreated in the usual way, as is known to the person skilled in the art, for example by being blasted with ceramic particles.

In preferred embodiments of the method according to the invention, the dental ceramic material is discharged via a spray jet with a small discharge angle (aperture angle). These angles are preferably <20°, in particular between 5° and 20°.

### EXAMPLE

A standard spray can which is known, for example, for the application of paints is filled with a mixture/suspension of a commercially available opaque (product IMAGINE REFLEX produced by the Applicant) in ethanol. This is done as follows.

56% by weight of the opaque (a cloudy silicate glass ceramic) is mixed with 44% by weight of ethanol to form a paste. 40.5 g (corresponds to 30 ml) of this paste are introduced into the container of a commercially available spray can, and this container is closed off in the usual way by the fitting of a spray head. Then, 11.5 g of a propane-butane propellant gas mixture (corresponds to approx. 20 ml) are introduced into the spray can through the spray head so that a pressure is built up (2.7 bar). This corresponds to a paste: propellant gas volumetric ratio of 3:2.

After the spray can has been shaken prior to use, the surface of a dental metal frame which has been produced using standard process steps is sprayed from a distance of approx. 2 to approx. 3 cm. The very fine discharge with a discharge angle of approx. 5° to 10° results in a thin opaque layer (layer thickness approx. 100 μm) with even coverage on the frame. The immediate evaporation of the propellant gas and of the solvent immediately results in a dry, securely bonded and durable layer. The pre-drying of an applied opaque which has hitherto been required prior to the actual firing operation in a ceramic kiln is substantially eliminated. The opaque layer obtained fulfills all the requirements which are usually imposed on such layers by a dental technician.

1-18. (canceled)

19. A discharge device for dental purposes, characterized in that it is filled with a dental ceramic material in dispersible form, in particular in the form of a solution and/or suspension.

20. The discharge device as claimed in claim 19, wherein the ceramic material is a dental opaque.

21. The discharge device as claimed in claim 19, wherein the discharge device is a spray device, in particular a spray can.

22. The discharge device as claimed in claim 19, wherein the solution and/or suspension contains at least one, preferably polar, solvent.

23. The discharge device as claimed in claim 22 wherein the polar solvent is at least one alcohol, preferably ethanol.

24. The discharge device as claimed in claim 19, wherein the ceramic material is introduced into the discharge device as a pasty material formed by a ceramic powder in a solvent, said pasty material forming, together with a preferably gaseous propellant, the filling of the discharge device.

25. The discharge device as claimed in claim 24, wherein the quantitative ratio of ceramic powder to solvent in the pasty material is between 1:4 and 4:1, preferably between 2:3 and 3:2.

26. The discharge device as claimed in claim 25, wherein the quantitative ratio of ceramic powder to solvent in the pasty material is between 1:1 and 3:2.

27. The discharge device as claimed in claim 24, wherein the ceramic powder has a particle size (d₅₀ value) of <80 μm, preferably <30 μm.

28. The discharge device as claimed in claim 27, wherein the particle size (d₅₀ value) is between 2 μm and 20 μm, preferably between 3 μm and 8 μm.

29. The discharge device as claimed in claim 24, wherein the volumetric ratio of ceramic powder to gaseous propellant is between 1:5 and 5:1, preferably between 1:1 and 5:1, in particular between 1:1 and 2:1.

30. A dental ceramic material, in particular in the form of a solution and/or suspension, characterized in that it is in the form of a filling for a discharge device, in particular in the form of a filling for a spray can.

31. The dental ceramic material as claimed in claim 30, characterized in that it is a dental opaque.

32. The dental ceramic material as claimed in claim 30 further characterized wherein the discharge device is a spray device, in particular a spray can.

33. A method for applying a dental ceramic material, preferably a dental opaque, to a base, in particular to a dental frame, wherein the ceramic material is applied in dispersed form, in particular in the form of a solution or suspension, with the aid of a spray device, in particular a spray can.

34. The method as claimed in claim 33, wherein the ceramic material is discharged via a spray jet with a small discharge angle.

35. The method as claimed in claim 34, wherein the discharge angle is <20°, preferably between 5° and 20°.

36. The method as claimed in claim 33, wherein the dental frame is a metal frame.
